(19) United States
(12) Patent Application Publication
(10) Pub. No.: US 2026/0351128 A1
(43) Pub. Date: Nov. 5, 2026

(54) Intaglio Letter Plate Alphabet Learning Tool

(71) Applicant: Chang-keun YANG, Seoul (KR)

(72) Inventors: Chang Keun Yang, Seoul (KR); Hye Na Yang, Seoul (KR); Se Wook Yang, Seoul (KR)

(21) Appl. No.: 19/486,376

(22) PCT Filed: May 23, 2024
(86) PCT No.: PCT/KR2024/007016

§ 371 Date: Nov. 20, 2025

(30) Foreign Application Priority Data
May 23, 2023 (KR) 10-2023-0066390

(51) Int. Cl. G09B 1/40

(52) U.S. Cl. CPC G09B 1/40

(57) ABSTRACT

This intaglio letter plate alphabet learning tool consists of two intaglio letter plates, an intaglio uppercase letter plate and an intaglio lowercase letter plate, which a plurality of engraved vertical lines, a plurality of engraved horizontal lines and an engraved circle (semicircles, etc.) form various alphabet letters by intersecting each other. By inserting various colored materials into these lines and circle, all the alphabets are represented on intaglio letter plates. Young children can actively participate in tasks (principle of coding) and learn the alphabet and using multisensory learning methods such as visual sense, touch sense, and taste sense. This learning tool is an excellent learning aid as it improves on the existing teaching aids that make learning difficult with whole letters, as it allows children to learn the alphabet and words in an easy and fun way by engraving letters on a plate using a multisensory method.

### TECHNICAL FIELD

The present invention belongs to the technology of a learning tool that helps young children learn the alphabet (“the alphabet below refers to the Roman alphabet”). More specifically, the present invention combines line and circle segments which are creating the proto-letter as the basis for letter formation, based on the identification lines of the intaglio engraved on two monogram-type intaglio letters of different sizes, so that uppercase letters and lowercase letters can be represented, respectively. it belongs to the technical field of teaching aids that can improve alphabet learning efficiency by enabling easy and enjoyable learning of the letters represented therein through a multi-sensory learning method.

### TECHNOLOGY BEHIND THE INVENTION

Young children face significant difficulties learning letters due to prolonged exposure to entertainment-focused audiovisual content, such as game videos, from a young age.

Existing teaching methods are characterized by focusing on memorizing whole words without addressing the abstract nature of the alphabet. Therefore, the problem is serious because young children who are first exposed to this type of educational method have a low motivation to learn and their learning efficiency is significantly reduced.

The present invention is designed to prevent young children who are learning a second foreign language for the first time from falling into difficult and boring learning due to the difficulty of abstraction by starting from the full alphabet and consolidated alphabet phase of the fully acquired process, and to secure readiness to move on to learning the next spelling by acquiring line segments, such as the basic model of letter formation, by applying a brain science learning model in the previous stage of the basic learning process, thereby developing alphabet recognition ability.

This invention allows young children to acquire synesthesia of shapes (letters, figures, etc.) represented through the process of forming junctions by line segments (vertical lines, horizontal lines, diagonal lines, semicircles, circles) that are the original letter shapes engraved in a monogram-shaped engraved letter board in order to resolve the abstractness of the alphabet from the early stages of the formation principle of the alphabet (pre-alphabet and partial alphabet phase). In particular, it is characterized by the fact that all alphabets represented in the monogram are embodied in the brain as concrete and tangible realities (aka ‘alphabet in a box of letters’) rather than abstract symbols, and that learning is further enhanced by utilizing tools of multi-sensory learning methods.

It is designed to help young children learn phonics and words easily and enjoyably by developing the ability to match sounds and spellings through the acquisition of uppercase and lowercase alphabets, which is one of the first steps in early literacy. Furthermore, it is designed to enable learning through role-playing of inserting line segments in turn through interaction between young children and partners (educators, parents, colleagues, etc.).

Additionally, as children play role-playing with a partner, they can feel a sense of pride in having “created a letter” and experience the joy of becoming a “letter inventor,” establishing themselves as a model of creative learning.

However, young children are having trouble remembering alphabet and words owing to learning by existing whole-word learning materials, such as removable alphabet blocks. They struggle to recall the letters and words, leading to a lack of motivation. This leads to lengthy learning times and a failure to retain the letters and words in long-term memory.

### PRIOR ART REFERENCE

### Patent Document

Republic of Korea Patent No. 10-0040502 ‘Alphabet lowercase letter learning tool by combination of block modules’ (Publication date: 2023 Mar. 23.)

### CONTENT OF THE INVENTION

### Tasks to be Solved

In order to solve this difficult problem, the present invention takes advantage of the structural characteristics of the intaglio letter plate to help young children learn the alphabet and words, which are abstract symbols, in an easy and fun way using multisensory learning methods while actively learning the alphabet's principles.

The present invention is to solve the problem of easily forgetting and not being able to retrieve the alphabet and words learned in this way by keeping young children in mind for a long period of time.

In particular, we would like to solve the difficult problem of having great difficulty learning the lowercase letters because they cannot easily identify obfuscated letters (‘b’ ‘d’, ‘p’ ‘q’) due to mirror errors. This can prevent them from developing dyslexia in the first place.

The problem to be solved by the present invention is not limited to the problems mentioned above, and other technical problems not mentioned will be clearly understood by those skilled in the art from the description below.

### Means for Solving the Problem

The intaglio letter plate alphabet learning tool of the present invention to achieve the problem to be solved above is composed of two intaglio letter plates with a unified (monogram type) structure representing upper and lowercase letters of the alphabet, and the intaglio letters are of different sizes. Each is separate. The intaglio uppercase letter plate of the intaglio letter plate alphabet learning tool (hereinafter referred to as the “intaglio uppercase letter plate”) is indicated by a plurality of vertical lines formed by intaglio, a plurality of horizontal lines that intersect a plurality of vertical lines, and a plurality of intaglio letters. It includes an uppercase letter engraved dial formed by a plurality of diagonal lines and intaglios that intersect a vertical line and a plurality of horizontal lines, forming a circle (including two semicircles) that intersects one vertical line, one horizontal line, and a plurality of diagonal lines.

In addition, the intaglio lowercase letter plate of the intaglio letter plate alphabet learning tool (hereinafter referred to as the “intaglio lowercase letter plate”) is indicated by a plurality of vertical lines formed by intaglio, a plurality of horizontal lines that intersect a plurality of vertical lines, and a plurality of intaglio letters. It includes a lowercase letter engraved dial formed by a plurality of diagonal lines and intaglios that intersect a vertical line and a plurality of horizontal lines, forming a circle (including two semicircles) that intersects one vertical line, one horizontal line, and a plurality of diagonal lines.

In addition, the intaglio letter plate alphabet learning tool includes at least one of colored clay, colored straws, colored string, uneven string, colored sandpaper, colored wire, and high fructose corn syrup that can be accommodated in the intaglio uppercase letter plate and the intaglio lowercase letter plate to form the alphabet and words. It can contain one.

The intaglio uppercase letter plate and the intaglio lowercase letter plate may each include a coupling protrusion formed on one side and a protrusion receiving groove formed on the other side with a groove having a depth corresponding to the protruding length of the coupling protrusion.

### Effects of the Invention

The intaglio letter plate alphabet learning tool according to the present invention has structural characteristics that include the composition principles of letters represented in a unified (monogram type) form, allowing young children to create letters by making vertical lines, horizontal lines, diagonal lines, and circles (semicircles) as if they were playing. By learning the original shape of the formation and easily understanding the principles of the alphabet in the process of combining these line segments, they can learn the alphabet and words in an easy and fun way.

In particular, we enable young children to learn the alphabet and words more easily and in a fun way by using various sensory learning methods through the play process, and naturally engrave them into their brains so that they remain as long-term memories.

More specifically, the intaglio letter plate alphabet learning tool according to the present invention adds colored clay, colored straws, etc. to the intaglio uppercase letter plate and intaglio lowercase letter plate to make letters in various colors and allows learning letters through visual stimulation. By inserting color sandpaper and touching the color sandpaper, they can easily learn the obfuscated letters (‘b’ ‘d’, ‘p’ ‘q’) caused by mirror errors.

In this way, The intaglio letter plate alphabet learning tool uses an appropriate mix of multisensory methods to enable learning of the alphabet and words, and increases the learning effect of the alphabet and words.

It helps young children whose small muscles are not fully developed to learn the alphabet and words easily by arousing interest in learning through play such as tactile reading, which is learned through simple movements such as inserting materials before studying writing with a pencil.

In particular, the present invention can be made of silicone material that is resistant to high heat, so young children can make alphabet-shaped chocolates or cookies according to the intaglio letter plate, insert them, bake them, apply high-fructose corn syrup or honey, etc., and then lick them. It allows young children to acquire various sensory abilities while learning the alphabet and words. Furthermore, at a time when young children need to acquire multiple senses, the experience of learning the alphabet and words by directly participating in such baking work is fun and easy, rather than boring and arduous. By recognizing it as a play time, it eliminates resistance to learning the alphabet and words and creates strong motivation.

Accordingly, the intaglio letter plate alphabet learning tool according to the present invention can demonstrate high efficiency in learning the alphabet and words.

### BRIEF DESCRIPTION OF THE DRAWINGS

FIG. 1 is a diagram showing an intaglio uppercase letter plate of the intaglio letter plate alphabet learning tool (1) according to an embodiment of the present invention

FIG. 2 is a diagram showing an intaglio lowercase letter plate of the intaglio letter plate alphabet learning tool (1) according to an embodiment of the present invention.

FIG. 3 is a diagram showing the first vertical line, the second vertical line, the third vertical line, the first horizontal line, the second horizontal line, the third horizontal line, the first diagonal line, the second diagonal line, and circles (semicircles). that constitute the intaglio uppercase letter plate of FIG. 1.

FIG. 4 is a diagram showing the first vertical line, the second vertical line, the third vertical line, the first horizontal line, the second horizontal line, and the third horizontal line, the first diagonal line, the second diagonal line and small circle (semicircle) that constitute the intaglio lowercase letter plate of FIG. 2.

FIG. 5 is a diagram showing a state in which the intaglio uppercase letter plate engaging protrusion of the intaglio letter plate alphabet learning tool is accommodated in the protrusion receiving groove of another intaglio uppercase letter plate and a plurality of the intaglio uppercase letter plate are connected.

FIG. 6 is a diagram showing multiple senses used in the intaglio letter plate alphabet learning tool according to an embodiment of the present invention.

FIGS. 7 and 8 are diagrams showing various tools used in the intaglio letter plate alphabet learning tool according to an embodiment of the present invention.

FIGS. 9 to 16 are diagrams showing the tools shown in FIGS. 7 and 8 used in the intaglio letter plate alphabet learning tool according to an embodiment of the present invention.

### SPECIFIC DETAILS FOR CARRYING OUT THE INVENTION

The advantages and features of the present invention and methods for achieving them will become clear by referring to the embodiments described in detail below along with the accompanying drawings. However, the present invention is not limited to the embodiments disclosed below and may be implemented in various different forms. This embodiment is only provided to ensure that the disclosure of the present invention is complete and to those skilled in the art to which the present invention pertains. It is provided to fully inform the user of the scope of the invention. The invention is defined merely by the claims.

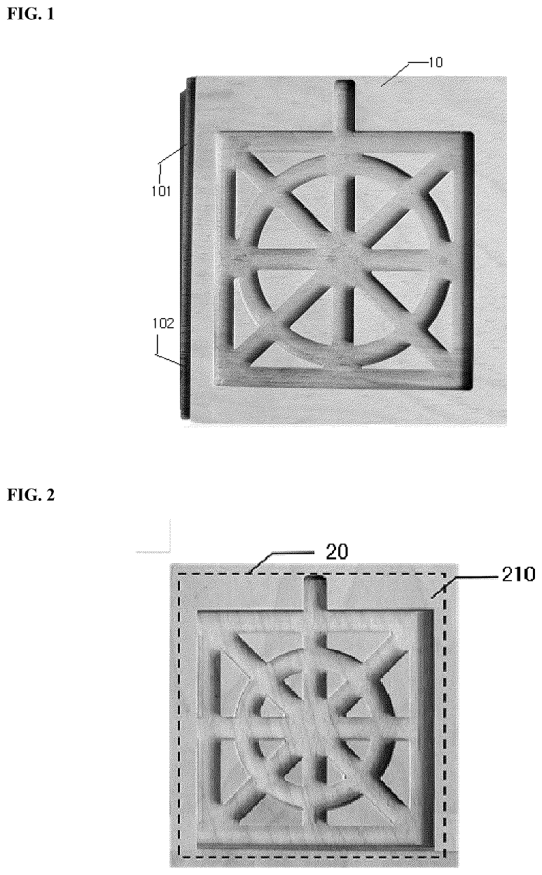

Hereinafter, the intaglio letter plate alphabet learning tool according to an embodiment of the present invention will be described in detail with reference to FIGS. 1 to 16.

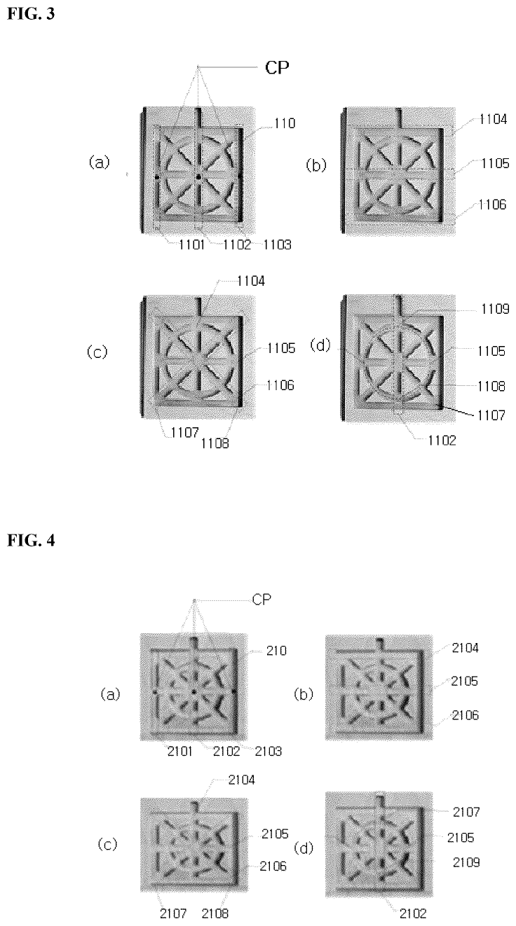

However, so that the description of the intaglio letter plate alphabet learning tool according to an embodiment of the present invention is concise and clear, an overview of the intaglio letter plate alphabet learning tool according to an embodiment of the present invention is given with reference to FIGS. 1 and 2. After the explanation, the components and operations that make up the intaglio letter plate alphabet learning tool will be described in detail with reference to the explained content and FIGS. 3 to 8. Next, a detailed description will be given of how the user utilizes the intaglio letter plate alphabet learning tool according to an embodiment of the present invention.

FIGS. 1 and 2 are diagrams showing an intaglio uppercase letter plate of the intaglio letter plate alphabet learning tool and a intaglio lowercase letter plate of the intaglio letter plate alphabet learning tool according to an embodiment of the present invention, respectively.

Unlike existing teaching aids that attach and detach letters such as blocks that have already been produced, the intaglio uppercase letter plate and the intaglio lowercase letter plate of the intaglio letter plate alphabet learning tool according to the present invention enable the creative creation of many alphabets on a single letter plate and the creation of letters by creating letters. It is a kind of monogram type plate with the feature of allowing you to learn the alphabet and words while learning the principles of coding.

The intaglio uppercase letter plate (10) and the intaglio lowercase letter plate (20) of the intaglio letter plate alphabet learning tool with these characteristics enable young children to learn the alphabet using multiple senses when learning the alphabet, making it easier and more fun to learn the alphabet, make it possible Moreover, it helps young children learn the alphabet and words by utilizing multiple senses and helps them remember the learned alphabet for a long time.

For example, the intaglio uppercase letter plate (10) and the intaglio lowercase letter plate (20) of the intaglio letter plate alphabet learning tool of the present invention have a plurality of vertical and horizontal lines and one circle on the intaglio uppercase letter plate (10) or the intaglio lowercase letter plate (20). By inserting colored clay, colored sandpaper, or colored clay, young children can learn the alphabet by creating colorful alphabets while stimulating their tactile and visual senses.

In addition, young children can learn the alphabet by putting sandpaper on the intaglio uppercase letter plate (10) or the intaglio lowercase letter plate (20) and touching the letters along the sandpaper with their fingers. Then, chocolate or cookies coated with alphabet-shaped high-fructose corn syrup are inserted into the intaglio uppercase letter plate (10) or the intaglio lowercase letter plate (20), so that the letters can be learned by licking the high-fructose corn syrup.

In other words, the present invention allows many shapes (letters, figures, etc.) to be created by adding clay, uneven materials, wire, sandpaper, and food materials to various line segments formed along a matrix framework.

In addition, the present invention can be made of silicone material that is resistant to high heat, so it is possible to bake letters with food materials and learn the alphabet and words through this baking experience, making alphabet learning a joyful time for young children. By recognizing it as a play time where you can have fun and learn easily, they can create strong motivation for learning the alphabet.

In this way, the present invention allows learning the alphabet through multiple senses such as a visual sense, touch sense and taste. sense. Compared to conventional letter learning materials, it allows the learned alphabet and words to be remembered for a long period of time, and converts letter learning time into play time. This helps to create strong motivation for learning the alphabet.

Hereinafter, the components constituting the intaglio letter plate alphabet learning tool according to an embodiment of the present invention will be described in detail with reference to FIGS. 3 to 5.

FIG. 3 is a diagram showing the intaglio uppercase letter plate (10) of FIG. 1. It is a drawing showing the first vertical line of the intaglio uppercase letter plate, the second vertical line, the third vertical line, the first horizontal line, the second horizontal line, the third horizontal line, the first diagonal line, the second diagonal line, and the circle (semicircle).

FIG. 4 is a diagram showing the intaglio lowercase letter plate (20) of FIG. 2. It is a drawing showing the first vertical line of the lowercase letter plate, the second vertical line, the third vertical line, the first diagonal line, the second diagonal line, the first horizontal line, the second horizontal line, and the second vertical line, and the circle (semicircle).

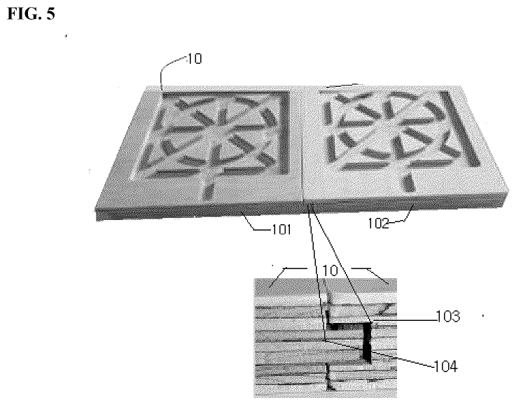

FIG. 5 shows that the combining protrusions of one intaglio letter plate alphabet learning tool are accommodated in the protrusion receiving groove of another intaglio letter plate alphabet learning tool, and a plurality of the intaglio letter plates connected reciprocally are shown.

The intaglio letter plate alphabet learning tool according to an embodiment of the present invention includes an intaglio uppercase letter plate (10) as shown in FIG. 1 and an lowercase letter plate (20) as shown in FIG. 2 as a component.

The intaglio uppercase letter plate (110) of the intaglio letter plate alphabet learning tool is formed by intaglio with a plurality of vertical lines (1101-1103) and a plurality of horizontal lines (1104-1106) that intersect a plurality of vertical lines (1101-103), two diagonal lines (1107, 1108) that are formed in intaglio and intersect a plurality of vertical lines (1101-1103) and a plurality of horizontal lines (1104-1106), and one vertical line (1102) is formed in intaglio. It also includes a one circle (1109) that contacts a plurality of vertical lines(1101-1103), a plurality of horizontal lines (1104-1106) and two diagonal lines(1107, 1108),

Here, a plurality of vertical lines (1101-1103) are, as shown in (a) of FIG. 3, the first vertical line (1101) located on the left, the second vertical lines (1102) spaced at a certain distance to the right from the first vertical line (1101) and the third vertical line (1103) spaced a certain distance to the right from the second vertical line 1102. At this time, the spacing between the first vertical line (1101) and the second vertical line (1102) and the spacing between the second vertical line (1102) and the third vertical line (1103) may be the same.

Here, the first vertical line (1101), the third vertical line (1103), and the second vertical line (1102) may be formed with different lengths. As illustrated in (a) of FIG. 3, the second vertical line (1102) may be formed longer than the first vertical line (1101) and the third vertical line (1103) and may protrude below the third horizontal line (1104). In addition, as illustrated in (b) of FIG. 3, a plurality of horizontal lines (1104-1106) may be the first horizontal line (1104) positioned above, the second horizontal line (1105) spaced a certain distance downward from the first horizontal line (1104), and the third horizontal line (1106) spaced a certain distance downward from the second horizontal line (1105). The second horizontal line (1105) can be formed by intersecting the center points (C.P.) of the first vertical line (1101), the second vertical line (1102) and the third vertical line (1103) shown in (a) of FIG. 3.

In addition, as shown in (c) of FIG. 3, the interval between the first horizontal line (1104) and the second horizontal line (1105), and the interval between the second horizontal line (1105) and the third horizontal line (1106) may be the same. And a plurality of diagonal lines (1107, 1108), as shown in (c) of FIG. 3, may be the first diagonal line (1107) extending from the rightmost point of the first horizontal line (1104) to the leftmost point of the third horizontal line (1106), and the second diagonal line (1108) extending from the leftmost point of the first horizontal line (1104) to the rightmost point of the third horizontal line (1106). And, as shown in (d) of FIG. 3, one circle (semicircle) (1109) can be formed with a size that is centered on the intersection of the second vertical line (1102) and the second horizontal line (1105) and touches the first vertical line (1101), the third vertical line (1103), and the first horizontal line (1104) and the third horizontal line (1106).

The intaglio uppercase letter plate (110) is composed of various line segments, as described above, arranged in a matrix, allowing young children to learn the correct strokes and order of the alphabet uppercase letters created on the intaglio letter plate.

The intaglio lowercase letter plate (20) of the intaglio letter plate alphabet learning tool includes an intaglio lowercase letter plate (210) as illustrated in FIG. 4.

The intaglio lowercase letter plate (210) includes a plurality of vertical lines (2101-2103) formed by engraving, a plurality of horizontal lines (2104-2106) formed by engraving and intersecting a plurality of vertical lines (2101-2103), a plurality of diagonal lines (2107, 2108) formed by engraving and intersecting a plurality of vertical lines (2101-2103) and a plurality of horizontal lines (2104-2106), and a circle (semicircle) (2109) formed by engraving and intersecting one vertical line (2102), one horizontal line (2105), and a plurality of diagonal lines (2107, 2108).

Here, a plurality of vertical lines (2101-2103) may be, as illustrated in (a) of FIG. 4, the first vertical line (2101) located on the left side of the intaglio lowercase letter plate, the second vertical line (2102) spaced a certain distance to the right from the first vertical line (2101), and the third vertical line (2103) spaced a certain distance to the right from the second vertical line (2102). At this time, the second vertical line (2102) may be formed longer than the first vertical line (2101) and the third vertical line (2103) and may protrude above the third horizontal line (2104).

Additionally, the interval between the first vertical line (2101) and the second vertical line (2102) and the interval between the second vertical line (2102) and the third vertical line (2103) may be the same. In addition, a plurality of horizontal lines (2104-2106) may be a first horizontal line (2104) located on the upper side of the engraved letter plate, a second horizontal line (2105) spaced a certain distance downward from the first horizontal line (2104), and a third horizontal line (2106) spaced a certain distance downward from the second horizontal line (2105), as illustrated in FIG. 4 (b). Here, the second horizontal line (2105) is formed by intersecting the center points (C.P.) of the first vertical line (2101), the second vertical line (2102), and the third vertical line (2103), as shown in (a) of FIG. 4.

At this time, the interval between the first horizontal line (2104) and the second horizontal line (2105) and the interval between the second horizontal line (2105) and the third horizontal line (2106) may be the same. In addition, a plurality of diagonal lines (2107, 2108) may be, as shown in (c) of FIG. 4, the first diagonal line (2107) extending from the rightmost point of the first horizontal line (2104) to the leftmost point of the third horizontal line (2106), and the second diagonal line (2108) extending from the leftmost point of the first horizontal line (2104) to the rightmost point of the third horizontal line (2106).

And, as shown in (d) of FIG. 4, one circle (semicircle) (2109) can be formed with a size that does not touch the first vertical line (2101) and the third vertical line (2103) and the first horizontal line (2101) and the third horizontal line (2103) with the intersection of the second vertical line (2102) and the second horizontal line (2105) as the center.

The lowercase letters of the alphabet made with the intaglio lowercase letter plate (210) can be learned by young children according to the correct strokes and order.

FIG. 5 is a drawing showing a state in which a connecting protrusion (104) of one intaglio letter plate alphabet learning tool is received in a protrusion receiving groove (103) of another intaglio letter plate alphabet learning tool, and a plurality of intaglio letter plate alphabet learning tools are connected.

The intaglio uppercase letter plate of the intaglio letter plate alphabet learning tool can be combined with another intaglio letter plate alphabet learning tool to display words composed of two or more alphabets. For example, as illustrated in FIG. 5, the joining protrusion of one intaglio letter plate alphabet learning tool can be received in the protrusion receiving groove of another intaglio letter plate alphabet learning tool.

Through these structural features, the intaglio letter plate alphabet learning tool can be combined with other intaglio letter plate alphabet learning tool, enabling users to learn words of two or more letters.

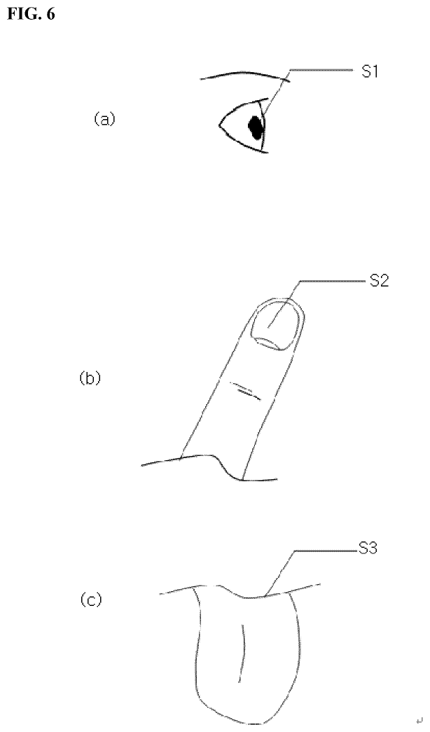

Hereinafter, with reference to FIGS. 6 to 8, a description will be given of the multiple senses and the various tools used in the intaglio letter plate alphabet learning tool according to one embodiment of the present invention.

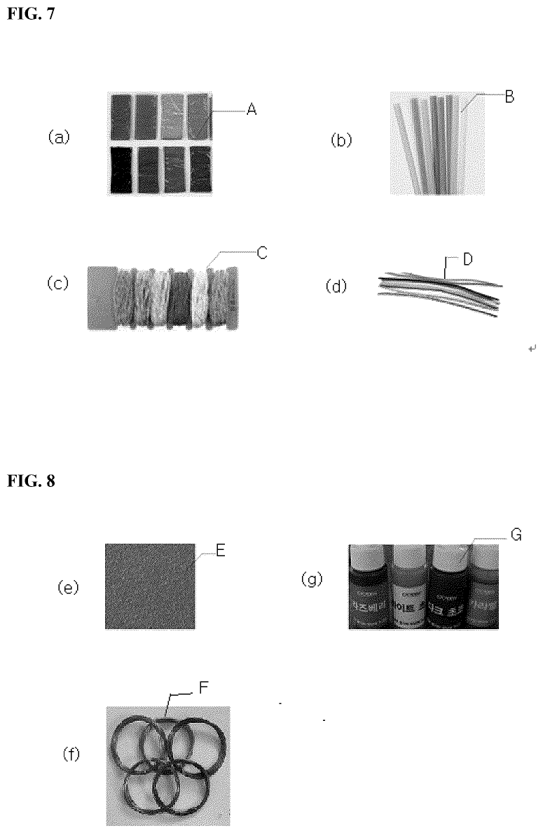

FIG. 6 is a diagram illustrating multiple senses used in intaglio letter plate alphabet learning tool according to one embodiment of the present invention, and FIGS. 7 and 8 are diagrams illustrating various tools used in an intaglio letter plate alphabet learning tool according to one embodiment of the present invention.

Users, i.e., young children, can learn the alphabet through the intaglio letter plate alphabet learning tool by utilizing multiple senses and tools.

And various tools used to stimulate such sensory organs may be colored clay (A) as shown in (a) of FIG. 7, colored straw (B) as shown in (b) of FIG. 7, colored string (C) as shown in (c) of FIG. 7, uneven string (D) as shown in (D) of FIG. 7, colored sandpaper (E) as shown in (e) of FIG. 8, colored wire (F) as shown in (f) of FIG. 8, and liquid fructose (G) as shown in (g) of FIG. 8.

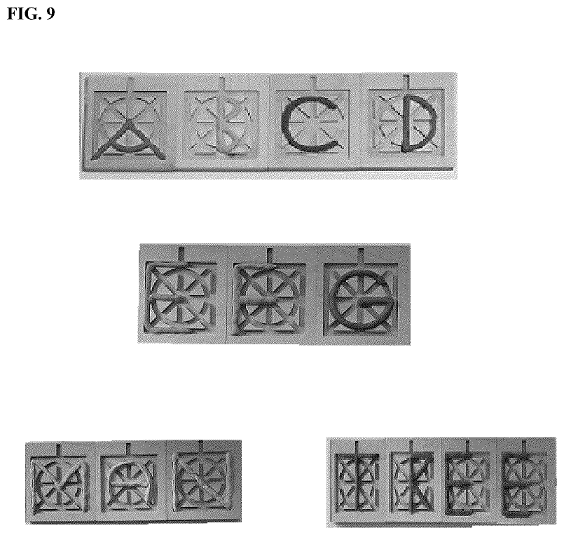

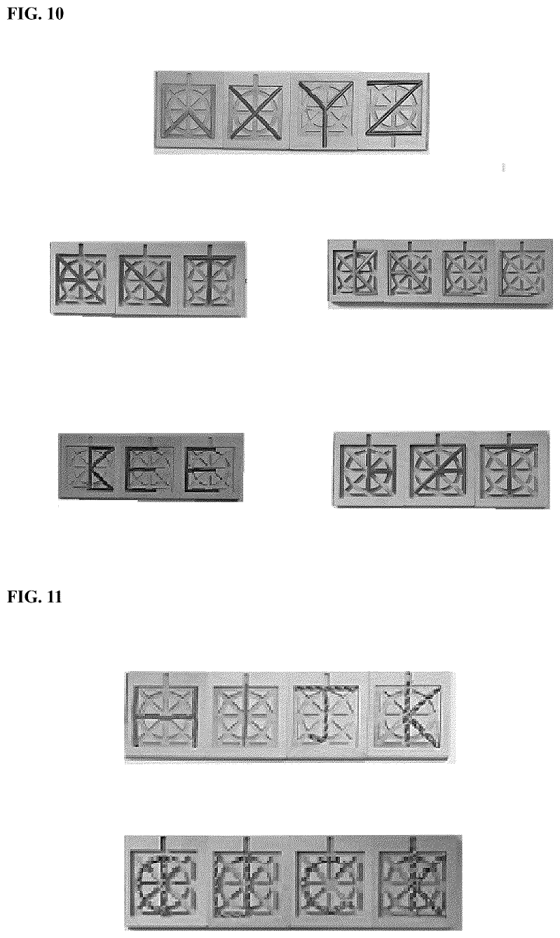

Hereinafter, with reference to FIGS. 9 to 16, examples of how letters can be formed using various tools in the intaglio letter plate alphabet learning tool will be specifically described.

Colored clay (A) can be formed into various letters by entering the intaglio uppercase letter plate (110) and the intaglio lowercase letter plate (210) of the intaglio letter plate alphabet learning tool. For example, the colored clay (A) is the alphabet ‘A’, ‘B’, ‘C’, ‘D’, ‘E, ‘F’ and ‘G’ as shown in FIG. 9 on the intaglio uppercase letter plate (110). ‘Letters and the words ‘TREE’ and ‘MAN’ can be formed respectively. Each letter formed in this way can be created with a variety of colors by using different colored clay for each stroke.

As shown in FIG. 10, the colored straw (B) enters the intaglio uppercase letter plat (110) of the intaglio letter plate alphabet learning tool and forms the letters ‘W’, ‘X’, ‘Y’ and ‘Z’, and the words ‘ANT’, ‘BALL’, ‘BEE’, and ‘HAT’ respectively can be marked

As shown in FIG. 11, the colored string (C) and the uneven string (D) can form various letters by entering the intaglio uppercase letter plate (110) of the intaglio letter plate alphabet learning tool, and as an example, the intaglio uppercase letter plate (110) is represented by the letters ‘H’, ‘I’, ‘J’and ‘K’ and the word ‘DUCK’, respectively.

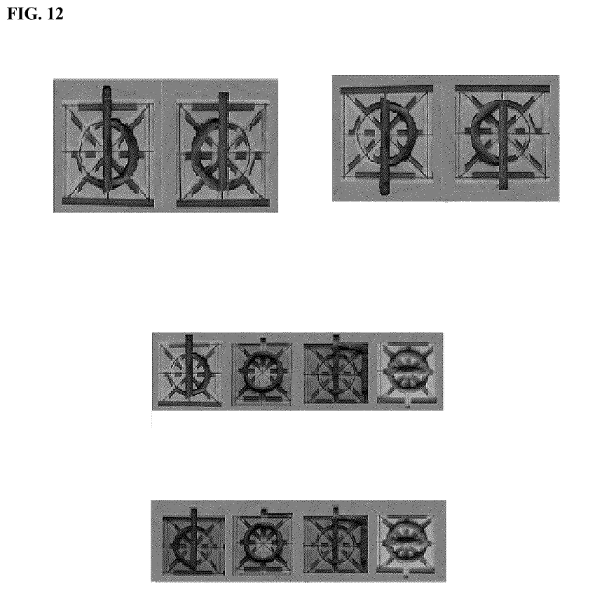

As shown in FIG. 12, the colored sandpaper (E) inserts the alphabet and words of the colored sandpaper into the intaglio lowercase letter plate (20) so that the letters can be clearly recognized. In particular, young children with immature left and right spatial senses code letters by tracing and exploring difficult letters made of rough sandpaper to the left or right using the tips of their sensitive fingers (the index and middle fingers), writing ‘b’ and ‘p’ to the right. By repeating the training of pointing and pointing d and q to the left, you can acquire the ability to identify mirror image corresponding letters of the alphabet ‘b’, ‘d’ and ‘p’, ‘q’ by mirror error. Through this, the patterns of difficult letters learned in the brain are imprinted in long-term memory, and the difficult alphabets (‘b’, ‘d’, ‘p’, ‘q’) as shown in FIG. 12 are combined with the alphabets and many words can be made. Even words such as ‘bone’, ‘done’, and many others can be easily recognized.

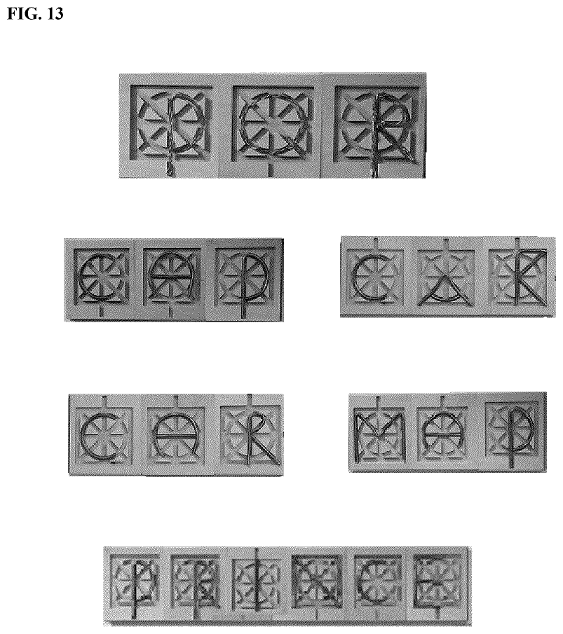

As shown in FIG. 13, the colored wire (F) can be formed into various letters by entering the intaglio uppercase letter plate (110). For example, the alphabets ‘P’, ‘Q’, and ‘R are displayed on the intaglio uppercase letter plate (110). ‘In letters, the words ‘CAP’, ‘CAR’, ‘MAP’ and ‘PRINCE’ are displayed on the intaglio uppercase letter plate (110), respectively.

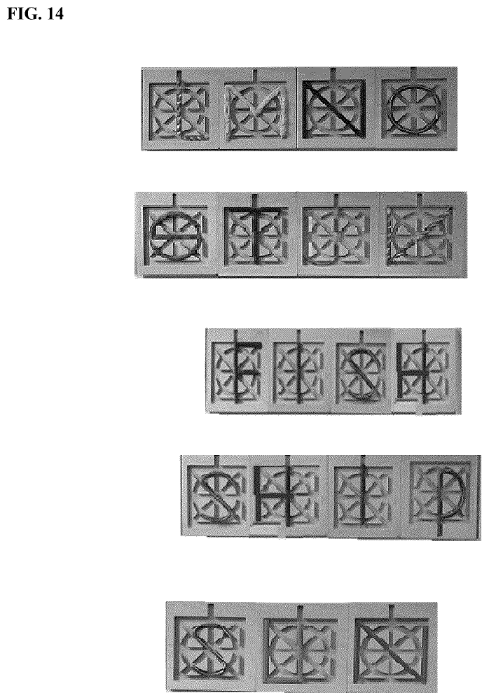

By mixing and inserting various tools, from colored clay (A) to colored wire (F), you can clearly recognize the alphabet and words. As an example, the mixed tool is inserted into the intaglio uppercase letter plate (110) to form the letters ‘L’, ‘M’, ‘N’ and ‘O’ as shown in FIG. 14, and the letters ‘S’ and ‘T’. ‘, ‘U’ and ‘V’ letters and the words ‘FISH’, ‘SHIP’ and ‘SUN’ respectively.

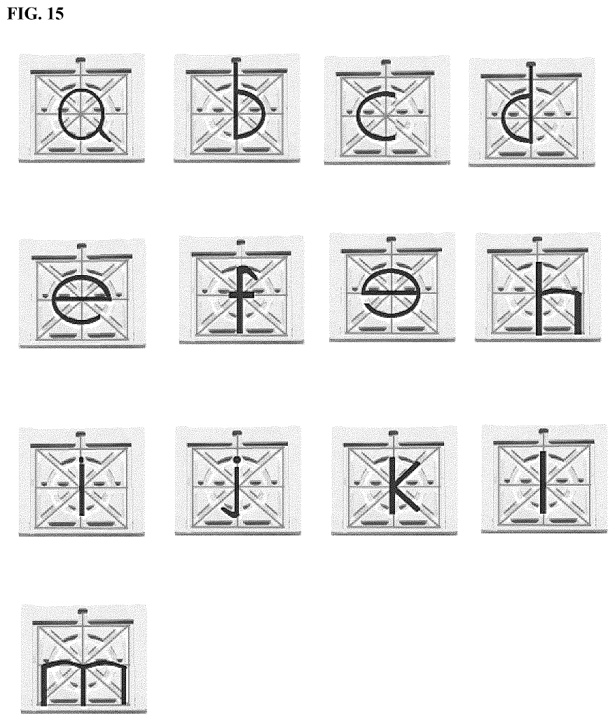

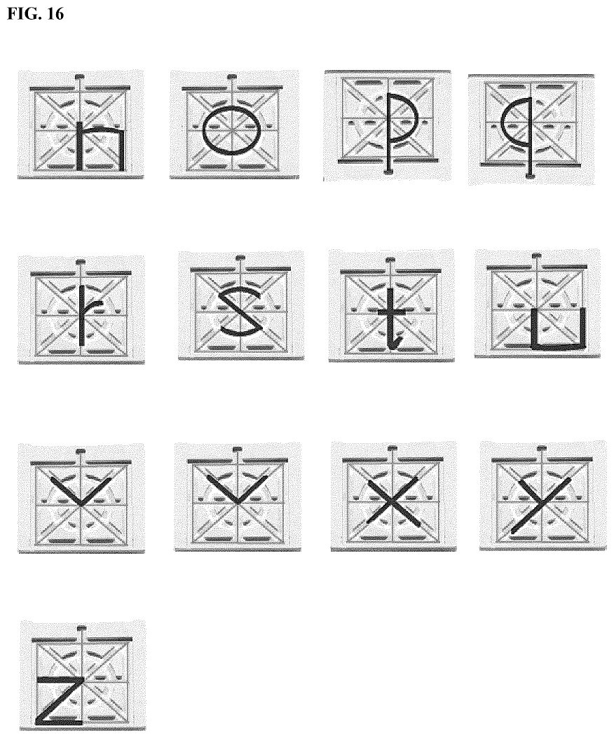

As mentioned above, each letter formed through colored clay (A), colored straw (B), colored string (C), uneven string (D), colored sandpaper (E), and colored wire (F) has a different stroke for each stroke. It may appear in color, and as an example, 26 alphabet lowercase letters from ‘a’ to ‘z’ as shown in FIGS. 15 and 16 are each made of a variety of above tools on the intaglio lowercase letter plate (20). So, a single alphabet or word can be displayed in a variety of colors and textures.

In this way, the various colors and textures applied to the alphabet and words represented in FIG. 9 to 16 stimulate multiple senses such as a visual sense, a taste sense, and a touch sense of young children, increasing the depth of brain memory and remaining as a pattern of long-term memory for further deepening. It will be a great driving force in learning English.

In particular, the present invention can be made of silicone material that is resistant to high heat, so young children can make alphabet-shaped chocolates or cookies according to the intaglio letter plate, insert them, bake them, apply high-fructose corn syrup or honey, etc., and then lick them. It allows young children to acquire various sensory abilities while learning the alphabet and words. Moreover, at a time when young children need to acquire multiple senses, the experience of learning letters by directly participating in such baking work is not a boring and arduous time, but an enjoyable and easy way to acquire them. By recognizing it as a fun play time, it eliminates resistance to learning the alphabet and words and creates strong motivation.

In this way, the intaglio letter plate alphabet learning tool according to the present invention allows young children to learn the alphabet through play actions of inserting colored clay, colored straws, and colored sandpaper into the intaglio uppercase letter plate (110) and the intaglio lowercase letter plate (210) before learning to write. It stimulates interest in learning words and makes it easy to learn letters.

In particular, the intaglio letter plate alphabet learning tool encourages learning the principles of letter formation through multiple senses in the process of creating uppercase and lowercase letters of the alphabet, allowing the learned principles to be imprinted in the brain as long-term memory, preventing mirror errors, even obfuscated letters (‘b’ ‘d’, ‘p’ ‘q’) can be easily recognized. Through this, the intaglio letter plate alphabet learning tool enables young children to achieve high efficiency in learning the alphabet and words.

Although embodiments of the present invention have been described with reference to the attached drawings, those skilled in the art will appreciate that the present invention can be implemented in other specific forms without altering the technical spirit or essential characteristics thereof. Therefore, the embodiments described above should be understood as illustrative and not restrictive in all respects.

### EXPLANATION OF SYMBOLS

1: Intaglio letter plate alphabet learning tool
10: Intaglio letter plate
110: Intaglio uppercase letter plate
1101: First vertical line of an intaglio uppercase letter plate
1102: Second vertical line of an intaglio uppercase letter plate
1103: Third vertical line of an intaglio uppercase letter plate
1104: First horizontal line of an intaglio uppercase letter plate
1105: Second horizontal line of an intaglio uppercase letter plate
1106: Third horizontal line of an intaglio uppercase letter plate
1107: First diagonal line of an intaglio uppercase letter plate
1108: Second diagonal line of an intaglio uppercase letter plate
1109: Circle of an intaglio uppercase letter plate
20: Intaglio lowercase letter plate
210: Intaglio lowercase letter plate
2101: First vertical line of an intaglio lowercase letter plate
2102: Second vertical line of an intaglio lowercase letter plate
2103: Third vertical line of an intaglio lowercase letter plate
2104: First horizon line of an intaglio lowercase letter plate
2105: Second horizon line of an intaglio lowercase letter plate
2106: Third horizontal line of an intaglio lowercase letter plate
2107: first diagonal line of an intaglio lowercase letter plate
2108: second diagonal line of an intaglio lowercase letter plate
2109: circle of an intaglio lowercase letter plate
A: Colored clay B: Colored straw C: Colored string D: Uneven string
E: Colored sandpaper F: Colored wire G: High fructose corn syrup
H: User
S1: Visual sense S2: Tactile sense S3: Taste sense

1. An intaglio letter plate alphabet learning tool (1) comprising an intaglio uppercase letter plate (10) formed with a plurality of vertical lines (1101-1103) of the intaglio uppercase letter plate, a plurality of letter horizontal lines of the intaglio uppercase letter plate (1104-1106) intersecting a plurality of vertical lines of the intaglio uppercase letter plate (1101-1103), a plurality of diagonal lines of the intaglio uppercase letter plate (1107, 1108) intersecting a plurality of vertical line of the intaglio uppercase letter plate (1101-1103) and a plurality of horizontal lines of the intaglio uppercase letter plate (1104-1106), and the intaglio uppercase letter plate of the intaglio uppercase letter plate (110) formed with a vertical line (1102), a horizontal line of the intaglio uppercase letter plate (1105), and a circle (1109) intersecting a plurality of diagonal lines of the intaglio uppercase letter plate (1107, 1108).

2. An intaglio letter plate alphabet learning tool (2) comprising an intaglio lowercase letter plate (20) formed with a plurality of vertical lines of the intaglio lowercase letter plate (2101-2103), a plurality of letter horizontal lines of the intaglio lowercase letter plate (2104-2106) intersecting a plurality of vertical lines of the intaglio lowercase letter plate (2101-2103), a plurality of diagonal lines of the intaglio lowercase letter plate (2107, 2108) intersecting a plurality of vertical lines of the intaglio lowercase letter plate (2101-2103) and a plurality of horizontal lines of the intaglio lowercase letter plate (2104-2106), and the intaglio lowercase letter plate of the intaglio lowercase letter plate (210) formed with a vertical line (2102), a horizontal line of the intaglio lowercase letter plate (1105), and a circle (2109) intersecting a plurality of diagonal lines of the intaglio lowercase letter plate (2107, 2108).

3. According to paragraph (1), colored clay (A), colored straw (B), gunny string (C), uneven string (D), colored sandpaper (E), colored wire (F) and high fructose corn syrup (G) that can be accommodated in the intaglio uppercase letter plate (110) to form letters or numbers, and A intaglio may be used in the uppercase letter plate of the intaglio letter plate alphabet learning tool by choosing at least one of the above multiple letter materials.

4. According to paragraph (2), colored clay (A), colored straw (B), gunny string (C), uneven string (D), colored sandpaper (E), colored wire (F) and high fructose corn syrup (G) that can be accommodated in the intaglio uppercase letter plate (210) to form letters or numbers, and A intaglio may be used in the lowercase letter plate of the intaglio letter plate alphabet learning tool by choosing at least one of the above multiple letter materials.

5. According to paragraph 1, the intaglio uppercase letter plate (10) includes a coupling protrusion

(104) formed on one side and a protrusion receiving groove (103) having a depth corresponding to the protruding length of the coupling protrusion (101) on the other side.
